(19) United States
(12) Patent Application Publication
(10) Pub. No.: US 2026/0335796 A1
(43) Pub. Date: Oct. 29, 2026

(54) Filter Apparatus

(71) Applicant: HYDAC FluidCareCenter GmbH, Sulzabch/Saar (DE)

(72) Inventor: Viktor Josef Lauer, Nalbach (DE)

(73) Assignee: HYDAC FluidCareCenter GmbH, Sulzabch/Saar (DE)

(21) Appl. No.: 19/113,623

(22) PCT Filed: Oct. 5, 2023
(86) PCT No.: PCT/EP2023/077613

§ 371 Date: Mar. 20, 2025

(30) Foreign Application Priority Data
Dec. 21, 2022 (DE) 10 2022 004 844.2

(51) Int. Cl. B01D 35/153; B01D 29/11; B01D 35/147; B01D 35/30

(52) U.S. Cl. CPC B01D 35/153; B01D 29/11; B01D 35/147; B01D 35/30; B01D 2201/165; B01D 2201/4092

(57) ABSTRACT

The disclosure relates to a filter comprising a filter housing at least comprising one housing part and an additional housing part, which accommodates a filter element and is releasably connected to the one housing part; and a valve device, which, with increasing separation of the two housing parts from one another, cuts off a fluid path between one connection point in the filter housing for feeding of unfiltered medium from an additional connection point in the filter housing for discharging of filtered medium and, in the event of a connection of the two housing parts to one another, opens the intended fluid path again, wherein the valve device has a valve slide, which can be moved in one of the housing parts and which shifts from an open position in which the valve slide opens the fluid path into a position in which the valve slide blocks the fluid path.

### CROSS-REFERENCE TO RELATED APPLICATIONS

This application claims priority to German Patent Application DE 10 2022 004 844.2, filed on Dec. 21, 2022 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter apparatus having a filter housing at least consisting of one housing part and a further housing part, which accommodates a filter element and is releasably connected to the one housing part, and having a valve device, which, with increasing separation of the two housing parts from each other, rapidly cuts off a fluid path between one connection point in the filter housing for the supply of unfiltered medium from a further connection point in the filter housing for the discharge of filtrate and, in the event of a connection of the two housing parts to each other, rapidly opens the aforementioned fluid path again.

EP 4 088 801 A1 discloses a filter apparatus having a filter housing which has two connection points, namely an inlet for unfiltered medium and an outlet for filtrate, and a replaceable filter element, a valve device being provided which, in an open position, enables a fluid flow between one of the connection points and the filter element and, in a closed position, prevents this fluid flow, and the valve device being movable between the open position and the closed position by means of an actuating device. In this way, it is possible to reliably prevent hydraulic fluid from flowing into the housing during the filter element change, even with pressurised hydraulic lines. For this purpose, the valve device has an inflow valve, which is arranged in the fluid flow between the inlet and an outer side of the filter element as well as a further discharge valve, which is arranged in the fluid flow between an inner side of the filter element and the outlet. In this way, the known solution for preventing a fluid flow during a filter element change uses two independent valves which are spring-loaded and held in the direction of their closed position.

DE 10 2014 000 490 B4 discloses a filter apparatus with a filter housing which defines a main axis, in which filter housing at least one filter element can be replaceably accommodated and which has a housing bowl surrounding the respective filter element and a housing head which can be removably attached to said housing bowl, in which housing head at least one fluid guide provided for the outflow of filtrate is formed, and with a valve device associated with this fluid guide, which has a valve plate that blocks the outflow of filtrate in a closed position and allows it in a release position, and with a locking device, which, in a locking position, has a locking member that locks the valve plate of the valve device in the closed position, it being possible to move the locking member from the locking position to an ineffective unlocking position by means of lugs provided on the relevant filter element, the filter element in the functional position in the housing bowl acting mechanically on the locking member in the course of attaching the housing head to the housing bowl, the locking member being mounted in an axially displaceable manner along the main axis for its movement between locking position and unlocking position and being displaceable into the unlocking position due to contact with individual lugs on the filter element when the housing head is attached.

Furthermore, an annular body of the locking member cooperates with the valve plate via a spring arrangement which has a predefinable number of spring fingers, which are anchored with one end to the retaining ring in an arrangement distributed around the circumference of the throughflow opening and, in the unlocking position of the locking member, extend with their free ends outside the circumferential region of the valve plate, the annular body of the locking member having a conical control surface on its inner circumference, which, when the locking member moves into the locking position, strikes against the spring fingers and brings their free ends radially inwards into a position overlapping the edge of the valve plate which is in the closed position.

In this way, the filter apparatus is shut down for carrying out a filter element change and when the operating fluid pressure is lost, the valve plate of the valve device blocking the fluid supply returns to the closed position. As the valve plate acts parallel to the direction of fluid flow, any transverse forces are eliminated, which results in a reduction in frictional forces and therefore to a reduction in the necessary valve actuating forces. The latter results in turn in a reduced material load and in this respect allows the use of inexpensive materials, such as plastic materials.

### SUMMARY

A need exists to provide an improved filter apparatus by comparison which with few components enables a reliable, automatic shut-off of fluid lines connected to the filter apparatus during a filter element change. The need is addressed by the subject matter of the independent claim(s). Embodiments of the invention are described in the dependent claims, the following description, and the drawings.

### BRIEF DESCRIPTION OF THE DRAWINGS

FIG. 1 shows an example filter apparatus as a whole in the manner of a longitudinal section;

FIG. 2 shows an enlarged detail of the circle shown in FIG. 1; and

FIG. 3 shows a partial view of the example filter apparatus rotated by 90 degrees, viewed in the direction of the arrow in FIG. 1.

### DESCRIPTION

In some embodiments, it is provided that the valve device has valve spool which is longitudinally displaceable at least in one of the housing parts and which, under the influence of the respective installation situation for the filter element, moves from an open position releasing the fluid path to a position blocking the fluid path and vice versa. By using a valve spool instead of spring-loaded check valves with valve discs as demonstrated in prior art, an apparatus solution is created, by means of which the annoying leakage of fluid, such as hydraulic oil, from the line connections is prevented when the filter element is changed. In this respect, reliable automatic shut-off of the connected lines is achieved during a filter element change during which a spent element is replaced with a new element. Overall, the use of a valve spool achieves a cost-effective, filter-integrated solution and eliminates the need to install additional shut-off devices, such as stopcocks, check valves, fittings, etc. Furthermore, permanent pressure losses are prevented, such as would otherwise inevitably result due to prior art check valves located in the flow or additional fittings.

Since the valve spool returns in any case to its position blocking the fluid path between the fluid connection points when the filter element is removed, unintentional operation without a filter element, which could damage a hydraulic circuit with its connected components, is reliably prevented, so that in this respect the slogan-like claim “no element no flow” is satisfied. Accordingly, operating errors and malfunctions are also ruled out.

In some embodiments of the filter apparatus, it is provided that the valve spool has a central channel through which a transverse channel passes, which, in the open position of the valve spool, as part of the fluid path, establishes a fluid connection between the central channel and one of the two connection points in the filter housing and closes it in its blocking position. It is for example further provided that the valve spool has a channel guide on the outer circumference, which, as part of the fluid path, establishes a fluid connection between the other of the two connection points and an outer circumference of the filter element in the open position and closes it in the blocking position. In this way, operation free of lateral forces is achieved for the valve spool between its two functional positions “open” or “closed”; as well as unobstructed operation. The channel-like guidance of the fluid path achieves particularly gentle filter operation, in which the flow through the filter element, which element is supported on the inner circumference by a fluid-permeable supporting body, such as a supporting tube, is from the outside to the inside, i.e., the unfiltered medium flow is supplied on the outer circumference of the filter element and the cleaned fluid is discharged in the form of filtrate on the inner circumference thereof.

In some embodiments, it is further provided that the valve spool has, on its side directed towards the filter element, a coupling element, in particular in the form of an external thread, which cooperates in a releasable manner with a further coupling element on the filter element, in particular in the form of an internal thread, in particular enters into a screw connection in a releasable manner. In this way, the required coupling between the filter element and the valve spool can be produced in a cost-effective and space-saving manner.

For unobstructed operation, it is also beneficial if the valve spool is pre-stressed in the direction of its blocking position by means of an energy accumulator, in particular in the form of a compression spring.

For a central force application on the valve spool which is gentle on the material, it is beneficial if the valve spool and the filter element are arranged concentrically with the longitudinal axis of the filter housing of the filter apparatus.

In some embodiments of the filter apparatus, it is provided that the valve spool together with the connection points and the associated part of the fluid path is accommodated in a filter head as the one housing part and the filter element in a filter bowl as the further housing part, which can be connected to the one housing part in a releasable manner, in particular can be screwed thereto. In this way, the fluid control device with the associated piping can be fixed to a filter head, which routinely remains stationary on the hydraulic circuit, whereas the replaceable filter element is accommodated such that it can be uncoupled, in particular unscrewed, from the filter housing via a separate filter bowl.

In this case, it is for example provided that, in an assembled state, in particular a screwed-together state, of the two housing parts and with the filter element inserted, the central channel of the valve spool opens into the interior of the hollow cylindrical filter element, so that cavitation caused by any turbulence occurring during fluid guidance is prevented.

In some embodiments of the filter apparatus, it is provided that a friction coupling is present within the further housing part, which, when the filter element is screwed onto the valve spool as part of the process for screwing the further housing part onto the one housing part, terminates the process for screwing on the filter element and allows the process for screwing in the further housing part to continue, and that, as part of an unscrewing process, the friction coupling acts as a rigid coupling and likewise enables the process for unscrewing the further housing part together with the filter element in the opposite direction of rotation. This increases overall installation safety by ensuring that the filter element is first fixed to the valve spool in a defined manner, before the further housing part, in particular in the form of the housing bowl, is further fixed to the one housing part in the form of the filter head. In the opposite direction of rotation, the friction coupling acting as a rigid coupling is then used to unscrew both the filter bowl and the filter element from the filter head and the valve spool of the filter head, respectively. The threaded elements used here can differ in their pitch and/or in their number of turns in such a manner that it is ensured in any case that the filter element is already fixed to the valve spool of the housing head before the housing bowl is completely screwed into the housing head.

In some embodiments of the filter apparatus, it is provided that a bypass valve, which engages in the transverse channel, is connected in a part of the fluid path between the two connection points. In this way, in the event of blocking of the filter element in a case where it is largely clogged by the particle contamination and no longer allows any fluid flow to pass through, for the purpose of maintaining the function, it can be bypassed in such a manner that the unfiltered medium flow passes directly from the unfiltered medium side to the filtrate side of the filter apparatus via the bypass valve, which is then open. This is frequently harmless for the hydraulic circuit together with its connected components, as a large number of cleaning processes of the fluid have already been carried out in advance by the filter element, which in this respect is not yet clogged, and the fluid to be transported is therefore clean.

The filter apparatus is discussed in greater detail below with reference to further embodiments according to the FIGS.

Specific references to components, process steps, and other elements are not intended to be limiting. Further, it is understood that like parts bear the same or similar reference numerals when referring to alternate FIGS. The FIGS. are schematic and not necessarily to scale.

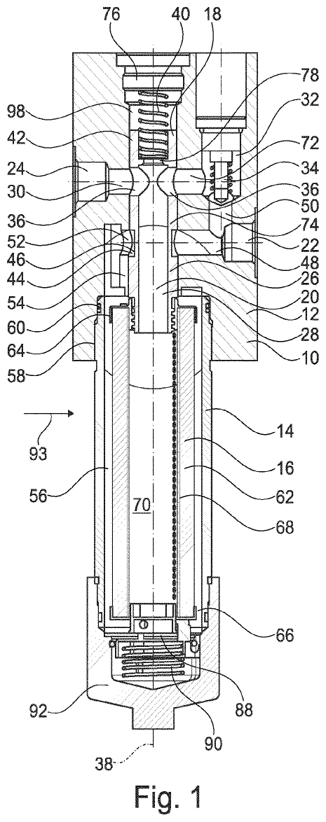

FIG. 1 shows the filter apparatus according to the teachings herein as a whole in the manner of a longitudinal section. The filter apparatus has a filter housing 10 with a first housing part 12 and a further second housing part 14, which accommodates a filter element 16 and is connected to the one housing part 12 in a releasable manner. The filter apparatus also has a valve device 18, which, with increasing separation of the two housing parts 12, 14 from each other, rapidly cuts off a fluid path 20 between a first connection point 22 in the filter housing 10 for the supply of unfiltered medium from a further second connection point 24 in the filter housing 10 for the discharge of filtrate and, in the event of a connection of the two housing parts 12, 14 to each other, rapidly re-opens the aforementioned fluid path 20 which will be explained in greater detail below. In this case, the valve device 18 has a valve spool 26 which is longitudinally displaceable in the first housing part 12 and which, under the influence of the respective installation situation for the filter element 16, moves from an open position releasing the fluid path 20 to a position blocking this fluid path 20 and vice versa.

As FIG. 1 also shows, the valve spool 26 has a central channel 28 configured in the manner of a hollow cylinder, which is circular when viewed in cross-section, through which central channel a transverse channel 30, with a smaller free cross-section by comparison, passes in its upper end region viewed in the direction of FIG. 1. For this purpose, the transverse channel 30 opens at its one free end into the second connection point 24 and with its other free end into a receiving chamber 32, which is used to receive a bypass valve 34, which is inserted into the first housing part 12 from above, in particular is screwed in from above. For the crossing of the central channel 28 through the transverse channel 30, the valve spool 26, in its open position shown in FIG. 1, which releases the fluid path 20, has two bores 36, which are arranged at the same level in the valve spool 26 and are diametrically opposite each other in relation to the longitudinal axis 38 of the second housing part 14 together with filter element 16. The free diameter of the two bores 36 substantially corresponds to the free diameter of the transverse channel 30. When the valve spool 26 assumes its position blocking the fluid path 20, it moves downwards, viewed in the direction of FIG. 1, with the aid of an energy accumulator in the form of a compression spring 40, which is only possible if at least the filter element 16 is removed from the filter apparatus. During the aforementioned downward movement of the valve spool 26, it closes the transverse channel 30 with an annular wall region 42, which is arranged above the two bores 36, along its two openings which are opposite the valve spool 26 and are formed by the two bores 36.

Furthermore, the valve spool 26 has a channel guide 44 on the outer circumference, which forms a rectangular annular groove when viewed in cross-section, which groove encompasses the valve spool 26, the groove base of the channel guide 44 being formed from a remaining hollow cylindrical wall part 46 of the valve spool 26. In the open position of the valve spool 26 shown in FIG. 1, the channel guide 44 opens into a horizontally extending fluid channel 48, which opens out at its other free end into the first connection point 22 which is widened in diameter. A vertically extending branch channel 50, which is closed at its upper free end by a bypass valve 34, opens into the transition region between the fluid connection point 22 and the fluid channel 48.

On the other side opposing the fluid channel 48, a channel section 52 opens into the circumferential channel guide 44 in the one housing part 12, the channel section 52 opening out in turn at its other free end into a vertically extending transition channel 54, which at its lower free end opens out into an unfiltered medium chamber 56 in the second housing part 14, which unfiltered medium chamber is defined on the outside by the inner wall of the second housing part 14 and on its inner side by an outer circumferential surface of the filter element 16. In this respect, the second further housing part 14 is open at its upper end, so that in this respect a kind of filter bowl is created, which is screwed with an external thread along a threaded section 58 to the internal thread of the first housing part 12, which insofar forms a kind of filter head. In particular, the aforementioned filter head is connected in a fluid-conducting manner via its two connection points 22, 24 to piping of a hydraulic circuit which is not shown in greater detail. In this respect, the housing head forms a stationary part of the filter apparatus and the filter bowl 14 with the filter element 16 can be unscrewed from the filter head as a mobile part of the filter apparatus, so that in this respect a coupling connection is created between the one housing part 12 and the further housing part 14. To ensure that the threaded connection is pressure-tight over the threaded section 58, a sealing device 60 in the form of at least one O-sealing ring can be arranged on the free end of the filter bowl 14.

The filter element 16 consists, as usual, of a pleated filter medium 62 made of a plurality of element layers, which filter medium extends between an upper end cap 64 and a lower end cap 66, the upper end cap 64 not being shown in FIG. 3 for the sake of simplicity. Starting from the unfiltered medium chamber 56, the flow through the pleated filter medium 62 is from outside to inside and it is supported on its inner circumference in the usual manner on a fluid-permeable supporting body in the form of a supporting tube 68 and, for the sake of simplicity, only some of the circular fluid passages are shown, which passages extend between the upper and the lower end cap 64, 66 and are arranged in longitudinal rows at a predefinable distance from one another. In this respect, the filter element 16 encompasses a filtrate chamber 70 in a hollow cylindrical manner, which filtrate chamber is permanently connected in a fluid-conducting manner to the central channel 28 when the valve spool 26 is in the open position as shown. Towards the bottom, however, the aforementioned filtrate chamber 70 is closed fluid-tight via the closed lower end cap 66.

Viewed in the direction of fluid throughflow, the fluid path 20 referred to in the first housing part 12 thus consists of the first connection point 22, the horizontally extending fluid channel 48, the annular channel guide 44 in the valve spool 26, the channel section 52 in extension to the channel 48 on the opposite side, the vertical transition channel 54, the unfiltered medium chamber 56, the fluid passage points in the filter medium 62, the filtrate chamber 70, the vertical central channel 28, at least one of the bores 36, the transverse channel 30 and the second further fluid connection point 24. The further bore 36 in the valve spool 26, with the transverse channel 30, which in this respect is extended at this point, together with the receiving chamber 32 for the bypass valve 34 and the further vertical branch channel 50, forms a bypass path 72, which comes into operation if the filter medium 62 is clogged and the fluid path 20 is blocked in this region and, under the increasing inlet pressure at the first connection point 22, the valve body of the spring-loaded check valve, as the bypass valve 34, opens and releases the direct fluid connection between the first connection point 22 and the second connection point 24 while bypassing the filter element 16. In this case, when the bypass valve 34 is open, fluid flows from the first connection point 22 and the channel 50, which enters in a branch-like manner, into the transverse channel 30 via the relevant receiving chamber 32 and in this respect via the two bores 36 and the central channel 28 to the outlet side, i.e. to the second connection point 24.

The requirement for the aforementioned fluid paths 20, 72 is that the valve spool 26 assumes its open position shown in FIG. 1. However, if when the filter element 16 is removed, the tubular valve spool 26 assumes its closed position, the channel guide 44 disengages with the adjacent fluid channels 48, 52, 54 of the fluid path 20 and both the horizontal fluid channel 48 and the channel section 52, which also extends horizontally at the same level, are overlapped by the wall section 74 of the valve spool 26 which is located above them and is blocked in such a manner that in this respect the described fluid path 20 is also completely blocked. The compression spring 40 referred to for actuating the valve spool 26 rests with its one free end on a housing plug 76, which in this respect can be screwed into the housing part 12, and with its other free end on a closure part 78, which in this respect blocks the central channel 28 upwards above the two bores 36.

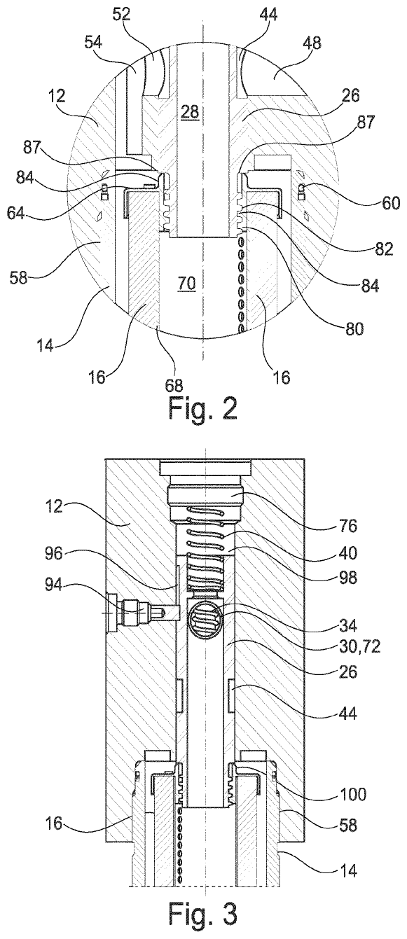

As FIG. 2 shows in particular, the filter element 16 is guided via an internal thread 80 so that it can be screwed to an external thread 82 on the lower end of the valve spool 26, a further second threaded section 84 in coaxial arrangement with the one first threaded section 58 being formed in such a manner between the valve spool 26 and the filter element 16. In particular, the axial overall length of the further threaded section 84 is shorter than the overall length of the one threaded section 58 between the two housing parts 12, 14. The internal thread 80 of the upper end cap 64 extends for a predefinable distance along the inner circumference of the supporting tube 68 in its upper end region. In extension of this internal thread 80, an edge 86 protrudes upwards, viewed in the direction of FIG. 2, which as a stop edge is used in the fixed state of the filter element 16 to come into contact with the underside of the valve spool 26 in its open position shown in FIG. 1, for which purpose the external thread 84 is correspondingly reduced in its diameter with respect to the lower contact surface 87 of the valve spool 26.

Furthermore, a friction coupling 88, which cooperates with a further compression spring 90, is provided at the lower end of the filter element 16. In this case, the friction coupling 88 is a component part of the further housing part 14, which, when the filter element 16 is screwed onto the valve spool 26 as part of the process for screwing the further housing part 14 onto the one housing part 12, terminates the process for screwing on the filter element 16, in that the filter element 16 comes into contact with the contact surface 87 of the valve spool 26 precisely via the edge 86, which valve spool incidentally moves upwards again from its lower valve or spool position blocking the fluid path 20 into its open position according to FIGS. 1 to 3 against the action of the compression spring 40. After the further threaded section 84 has been completely established via the internal thread 80 and external thread 82, it is possible, thanks to the friction coupling 88, to allow the process for screwing the further housing part 14 into the housing part 12 to continue until the threaded section 58 between the two housing parts 12, 14 is also completely established to this effect, in that the further housing part 14 simply assumes its completely screwed-in position according to the diagram of FIGS. 1 to 3.

In the reverse case, i.e. in the opposite direction of rotation of the further housing part 14, the friction coupling 88 now combined in one unit acts as a rigid coupling and likewise permits the process for unscrewing the further housing part 14 together with the filter element 16 from the one housing part 12 or from the external thread 82 of the valve spool 26. The aforementioned technical solution of a friction coupling 88 which can be converted into a rigid coupling in the opposite direction of rotation and back again, is described in all details in EP 3 352 876 B1 with the result that it will not be discussed in greater detail at this point.

In any case, the external thread 82 is reduced in diameter with respect to the other external diameter of the valve spool 26, in such a manner that the free end of the annular edge 86 of the upper element cap 64 can rest on the free end face of the valve spool in the installation situation. In this way, when the filter element 16 is screwed onto the valve spool 26, the latter can be moved upwards against the action of the compression spring 40. For this purpose, the external diameter of the outer circumference of the valve spool 26 substantially corresponds to the external diameter of the edge 86 of the element cap 64 while forming the stop. Otherwise, the external diameter of the valve spool 26 is kept substantially constant, as is its internal diameter, which forms the central channel 28. To be able to integrate an aforementioned friction coupling 88, which also acts as a rigid coupling, into the filter housing 10, the cylindrical housing shell of the further housing part 14 has a bowl receptacle 92 on its underside, which is screwed to the underside of the further housing part 14 in such a way that the housing part 14 can be moved in both directions of rotation or screwing by means of rotary movements on the bowl receptacle 92. In particular, the diagram of FIG. 1 makes it clear that if no filter element 16 is inserted in the further housing part 14, the valve spool 26 can also not come into its open or functional position shown. Rather, under the influence of the compression spring 40, the valve spool 26 is then pushed downwards into the interior of the housing part 14, thereby closing the above-mentioned channel sections of the fluid path 20 and, in this respect, the bypass path 72 is also closed. Only when the filter element 16 is inserted does the valve spool 26 assume its position shown in the FIGS. and the fluid path 20 is released for the upcoming filtration with the filter element 16, and the bypass valve 34 can come into operation if necessary.

The diagram in FIG. 3 along the arrow 93 in FIG. 1 shows the engagement of a locking screw 94 from the side into the valve spool 26, which locking screw is fixed within the first housing part 12. In this case, the free end of the locking screw 94 engages in a longitudinal channel 96 of a predefinable length, which is introduced in sections, on the outer circumference of the valve spool 26. The valve spool 26 is secured in its associated housing opening 98 in the housing part 12 in a longitudinally movable manner via the aforementioned locking screw 94 together with longitudinal channel 96, i.e. the valve spool 26 is also held in its bottommost blocking position in the housing receptacle 98 by means of the locking screw 94. In this case, the locking screw 94 drives in at the upper end of the longitudinal channel 98; otherwise, in the open position, at the lower end as shown in FIG. 3.

FIG. 3 shows an annular groove 100 which forms the transition from the outer circumference of the valve spool 26 to its external thread 82. It can also be seen that the upper end of the filter medium 62 is substantially flush with a notional extension of the upper run-out of the external thread 82. Otherwise, in the open position of the valve spool 26, its underside in the transition region to the annular groove 100 is flush with the lower end of the housing receptacle 98 of the housing part 12.

The filter apparatus solution means that oil losses can be prevented, so that there is no compelling necessity for topping up during any element change of the filter element 16. In addition to preventing oil contamination from entering the clean side of the filter apparatus, it has been shown that unintentional air entrainment can also be prevented during the element change. The connection solution via various threaded sections 58 and in particular 84 also makes it possible to implement reproduction protection, so that in particular it is prevented that filter elements 16 of low quality can be substituted. The annoying leakage of oil from the line connections 22, 24 when replacing the filter element is also prevented, for which purpose the valve spool 26 arranged centrally in the filter head 12 is likewise used and which valve spool closes automatically in a gravity-assisted manner when the filter bowl 14 is removed. This is inevitably supported by the spring force of the compression spring 40. Thus the valve spool 26 is already lowered when the filter bowl 14 is unscrewed from the filter head 12. The connection of the longitudinally movable valve spool 26 with its actuation via a friction coupling 88 known per se thus has no equivalent in prior art.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

What is claimed is:

1-10. (canceled)

11. A filter apparatus having a filter housing at least comprising one housing part and a further housing part, which accommodates a filter element and is releasably connected to the one housing part, and having a valve device, which, with increasing separation of the two housing parts from each other, cuts off a fluid path between one connection point in the filter housing for the supply of unfiltered medium from a further connection point in the filter housing for the discharge of filtrate and, in the event of a connection of the two housing parts to each other, rapidly opens the aforementioned fluid path again, wherein the valve device has a valve spool, which can be moved longitudinally at least in one of the housing parts and which shifts, under the influence of the particular installation situation for the filter element, from an open position in which the valve spool opens the fluid path into a position in which the valve spool blocks the fluid path and vice versa.

12. The filter apparatus of claim 11, wherein the valve spool has a central channel through which a transverse channel passes, which, in the open position of the valve spool, as part of the fluid path, establishes a fluid connection between the central channel and at least one of the two connection points in the filter housing and closes it in its blocking position.

13. The filter apparatus of claim 11, wherein the valve spool has a channel guide on the outer circumference, which, as part of the fluid path, establishes a fluid connection between the other of the two connection points and an outer circumference of the filter element in the open position and closes it in the blocking position.

14. The filter apparatus of claim 11, wherein the valve spool has, on its side directed towards the filter element, a coupling element, which cooperates in a releasable manner with a further coupling element on the filter element.

15. The filter apparatus of claim 11, wherein the valve spool is pre-stressed in the direction of its blocking position by an energy accumulator.

16. The filter apparatus of claim 11, wherein the valve spool and the filter element are arranged concentric with the longitudinal axis of the filter housing.

17. The filter apparatus of claim 11, wherein the valve spool together with the connection points and the associated part of the fluid path is accommodated in a filter head as the one housing part and the filter element in a filter bowl as the further housing part, which can be connected to the one housing part in a releasable manner.

18. The filter apparatus of claim 11, wherein, in the assembled state of the two housing parts and with the filter element inserted, the central channel of the valve spool opens out into the interior of the hollow cylindrical filter element.

19. The filter apparatus of claim 11, wherein a friction coupling is present within the further housing part, which, when the filter element is screwed onto the valve spool as part of the process for screwing the further housing part onto the one housing part, terminates the process for screwing on the filter element and allows the process for screwing-in the further housing part to continue, and wherein, as part of an unscrewing process, the friction coupling acts as a rigid coupling and likewise enables the process for unscrewing the further housing part together with the filter element in the opposite direction of rotation.

20. The filter apparatus of claim 11, wherein a bypass valve, which engages at least partially in the transverse channel, is connected in a part of the fluid path between the two connection points.

21. The filter apparatus of claim 12, wherein the valve spool has a channel guide on the outer circumference, which, as part of the fluid path, establishes a fluid connection between the other of the two connection points and an outer circumference of the filter element in the open position and closes it in the blocking position.

22. The filter apparatus of claim 11, wherein the valve spool has, on its side directed towards the filter element, a coupling element in the form of an external thread, which cooperates in a releasable manner with a further coupling element on the filter element.

23. The filter apparatus of claim 11, wherein the valve spool has, on its side directed towards the filter element, a coupling element in the form of an external thread, which cooperates in a releasable manner with a further coupling element on the filter element in the form of an internal thread and enters into a screw connection in a releasable manner.

24. The filter apparatus of claim 12, wherein the valve spool has, on its side directed towards the filter element, a coupling element, which cooperates in a releasable manner with a further coupling element on the filter element.

25. The filter apparatus of claim 13, wherein the valve spool has, on its side directed towards the filter element, a coupling element, which cooperates in a releasable manner with a further coupling element on the filter element.

26. The filter apparatus of claim 11, wherein the valve spool is pre-stressed in the direction of its blocking position by an energy accumulator in the form of a compression spring.

27. The filter apparatus of claim 11, wherein the valve spool together with the connection points and the associated part of the fluid path is accommodated in a filter head as the one housing part and the filter element in a filter bowl as the further housing part, which can be screwed to the one housing part in a releasable manner.

28. The filter apparatus of claim 12, wherein the valve spool is pre-stressed in the direction of its blocking position by an energy accumulator.

29. The filter apparatus of claim 13, wherein the valve spool is pre-stressed in the direction of its blocking position by an energy accumulator.

30. The filter apparatus of claim 14, wherein the valve spool is pre-stressed in the direction of its blocking position by an energy accumulator.
